(19) United States
(12) Patent Application Publication
(10) Pub. No.: US 2021/0338377 A1
(43) Pub. Date: Nov. 4, 2021

(54) DENTAL DAM FRAME AND METHODS OF USE THEREOF

(71) Applicants: John Ferone, Monmouth Beach, NJ (US); Allen Ali Nasseh, Boston, MA (US)

(72) Inventors: John Ferone, Monmouth Beach, NJ (US); Allen Ali Nasseh, Boston, MA (US)

(21) Appl. No.: 16/864,842

(22) Filed: May 1, 2020

(51) Int. Cl. A61C 5/82; A61C 17/08

(52) U.S. Cl. CPC A61C 5/82; A61C 17/08

(57) ABSTRACT

A dental dam having a frame and a pliable material is disclosed herein. The frame includes a tubular body having a central channel; a plurality of openings extending from an exterior surface of the tubular body and in fluid communication with the central channel; and a connection port extending from the tubular body and in fluid communication with the central channel, wherein the connection port is configured to be coupled to a vacuum line to provide a negative pressure area adjacent the tubular body.

### BACKGROUND

Many dental procedures are performed with the use of a dental dam, which includes a pliable material, such as, for example, rubber, stretched out over a frame. The pliable material typically includes a small opening which the doctor can place on a target area on which the dental procedure is being performed. As a result, the target area is isolated and protected from any contaminants and the patient's mouth is protected from any dental tools or other objects falling into it.

With the threat of infectious diseases, the safety of medical professionals, including dental and oral surgeons, from possibly being infected by their patients has become a source of concern.

### SUMMARY

The exemplary embodiments relate to a dental dam frame and methods of using same are disclosed herein. The dental dam frame includes a tubular body having a central channel; a plurality of openings extending from an exterior surface of the tubular body and in fluid communication with the central channel; and a connection port extending from the tubular body and in fluid communication with the central channel, wherein the connection port is configured to be coupled to a vacuum line to provide a negative pressure area adjacent the tubular body.

The exemplary embodiments further relate to a dental dam including a tubular body having a central channel; a plurality of openings extending from an exterior surface of the tubular body and in fluid communication with the central channel; a connection port extending from the tubular body and in fluid communication with the central channel, wherein the connection port is configured to be coupled to a vacuum line to provide a negative pressure area adjacent the tubular body; and a pliable material permanently coupled to the tubular body, wherein the pliable material includes an opening configured to be disposed over a target anatomical site.

The exemplary embodiments further relate to a dental dam including a tubular body having a central channel; a plurality of openings extending from an exterior surface of the tubular body and in fluid communication with the central channel; a connection port extending from the tubular body and in fluid communication with the central channel, wherein the connection port is configured to be coupled to a vacuum line to provide a negative pressure area adjacent the tubular body; a plurality of protrusions extending outwardly from the tubular body; and a pliable material extending over the tubular body and held in place by the plurality of protrusions, wherein the pliable material includes an opening configured to be disposed over a target anatomical site.

### BRIEF DESCRIPTION OF THE DRAWINGS

FIG. 1 is a perspective view of a dental dam frame according to various exemplary embodiments.

FIG. 2 is a front view of the dental damn frame of FIG. 1 according to various exemplary embodiments.

FIG. 3 is a rear view of the dental damn frame of FIG. 1 according to various exemplary embodiments.

FIG. 4 shows an exemplary dental dam assembly according to various exemplary embodiments.

FIG. 5 shows an exemplary dental dam assembly according to various exemplary embodiments.

FIG. 6A shows an exemplary dental dam assembly according to various exemplary embodiments.

FIG. 6B is a cross-sectional view of the dental dam assembly of FIG. 6A taken along B-B′.

### DETAILED DESCRIPTION

The exemplary embodiments may be further understood with reference to the following description and the related appended drawings, wherein like elements are provided with the same reference numerals. The exemplary embodiments relate to a dental dam assembly configured to create evacuate aerosol and/or contaminants from an area adjacent to the dental dam. The exemplary embodiments advantageously minimize or substantially eliminate contamination of the surgical site and the surrounding environment by the patient's breathing, which may pose a threat to the dental surgeon operating on the patient.

While dental dam assemblies have been successful in isolating a dental surgical site and preventing possible contamination of the surgical site, there exists a risk of the patient infecting the dental surgeon while breathing if the patient is sick. Furthermore, aerosols generated during dental procedures are also a potential hazard to dental staff, due to their role in the possible transmission of various airborne infections.

According to exemplary embodiments of the present disclosure, a dental dam assembly having a frame configured to evacuate an area adjacent the frame is described herein. The frame disclosed herein may be coupled to a vacuum source to create a negative pressure environment adjacent the frame. As a result, the patient's breath and any aerosol generated during the dental procedure that may otherwise become airborne and possibly infect the dental surgeon and any other staff in the procedure room is instead evacuated through the frame, thus preventing these elements from becoming airborne.

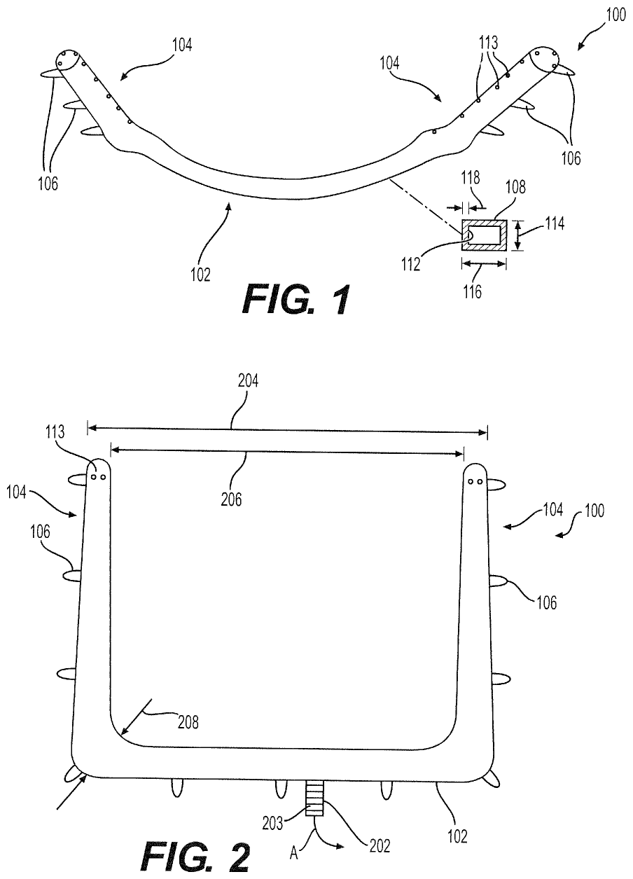

FIG. 1 is a perspective view of a dental dam frame 100 (hereinafter “frame 100”) according to various exemplary embodiments. In some embodiments, the frame 100 may include a base 102 and two arms 104 extending from the base 102. Each of the arms 104 includes a plurality of protrusions 106 configured to hold a pliable material (not shown in FIG. 1) against the frame 100. As illustrated in FIG. 1, the frame 100 is tubular and includes walls 108 having a thickness 110 and defining a central channel 112 extending throughout the frame 100. The frame 100 includes a plurality of openings 113 extending from an inwardly facing exterior surface of the frame 100 and in fluid communication with the central channel 112.

As shown in the cross-sectional view in FIG. 1, the frame 100 has a cross-sectional height 114, a cross-sectional width 116, and a wall thickness 118. In some embodiments, the cross-sectional height 114 may be about 6 mm, the cross-sectional width 116 may be about 10 mm, and the wall thickness 118 may be about 1 mm. However, it should be noted that these dimensions are exemplary and that the frame 100 may come in different sizes or shapes to accommodate the anatomy of different patients. In some embodiments, for example, the cross-sectional shape of the frame 100 (or any of the other frames described herein) can have a circular cross-section with an interior diameter of about 4 mm to about 20 mm and an exterior diameter of about 6 mm to about 23 mm.

The exemplary frame 100 may be constructed of any material that is approved for use in dental procedures. For example, if the frame 100 (or any of the other frames described herein) is a reusable frame, the frame may be constructed from stainless steel, anodized aluminum or any other material that may be sterilized between uses, e.g., autoclaved, chemiclaved, etc. Where the frame 100 (or any of the other frames described herein) is a one-time use frame, the frame may be constructed from a flexible material including, for example, a plastic material. As described herein, it should be understood that any of the embodiments may be reusable or one-time use.

FIG. 2 is a front view of the frame 100 of FIG. 1 according to various exemplary embodiments. The side of the frame 100 visible in FIG. 2 is the side that is opposite to a side of the frame 100 that would be adjacent to a patient's face (i.e., the side that the surgeon would see when looking at the frame placed against the patient's face). As illustrated in FIG. 2, the frame 100 further includes a connection port 202 extending from the base 102.

The connection port 202 is in fluid communication with the central channel 112 of the frame and is configured to be coupled to a vacuum/suction line (not shown) that is coupled to a vacuum source (not shown). When such a vacuum/suction line is coupled to the connection port 202, air flows from an area within the frame 100, through the openings 113, into the central channel 112, through the connection port 202, and into the line (as indicated by arrow A). In some embodiments, the connection port 202 may include one or more ridges 203 to improve the grip of the line on the connection port 202. However, it should be noted that this is only an example and that the vacuum/suction line may be coupled to the connection port via any conventional means (e.g., a clamp, frictional fit, etc.)

Although not depicted in FIG. 2, the frame 100 may include more than one connection port 202. For example, the frame 100 may include one connection port 202 on the right side of the frame 100 and second connection port 202 on the left side of the frame 100. In some embodiments, the central channel 112 may be divided into two central channels such that the left side of the frame is fluidly independent of the right side of the frame. As a result, the surgeon can choose which side of the frame to couple to a vacuum source such that only one side evacuates air from the surgical site. In other embodiments, the central channel may not be divided and either of the connection ports 202 may be used to evacuate the surgical site, e.g., the surgeon can select the port to use for evacuation based on the setup of the procedure room and the access to the patient. In such embodiments, the connection ports 202 may be provided with a mechanism such as a check valve (not shown) so that the connection port 202 that is not in use does not allow air to flow into the connection port when the other connection port is being used for evacuation.

As further illustrated in FIG. 2, in some embodiments, the frame 100 has an interior width 206 defined by the opposing surfaces of the arms 104 and exterior width 204 defined by the outermost surfaces of the arms 104. In some embodiments, the interior width 206 may be about 112 mm and the exterior width 204 may be about 123 mm. In some embodiments, corners of the frame 100 may include an increased width portion 208. In some embodiments, this increased width portion may have a width of about 15 mm. However, it should be noted that these dimensions are exemplary and that the frame 100 may come in different sizes to accommodate the anatomy of different patients.

FIG. 3 is a rear view of the frame 100 of FIG. 1 according to various exemplary embodiments. The side of the frame 100 visible in FIG. 3 is the side that would be adjacent to a patient's face. As illustrated in FIG. 3, the openings 113 may be distributed along the arms 104 sufficient to evacuate the area adjacent the frame 100 from any aerosol or patient breath. The number, size, shape and placement of the openings 113 may vary depending on the desired amount of airflow around the frame 100. As described above, in some exemplary embodiments, the openings 113 may be limited to the arms 104 of the frame 100. In other exemplary embodiments, the base 102 may include openings.

In addition, in the figures, the openings 113 are shown as generally circular openings. However, this is only exemplary as the openings 113 may have any shape, e.g., square, rectangular, elliptical, irregular, etc. In some exemplary embodiments, the openings 113 may be shaped as slits. The amount of air that is evacuated (e.g., the airflow) may depend on the shape and different shapes, sizes and placement may result in different amounts of airflow. The differing amounts of airflow of the different designs may be used for different procedures. For example, in procedures where there is a large amount of expected aerosol such as an impacted tooth extraction, a frame that has a greater amount of airflow may be used. In procedures where there is a smaller amount of aerosols expected to be generated, a frame that has a smaller amount of airflow may be used.

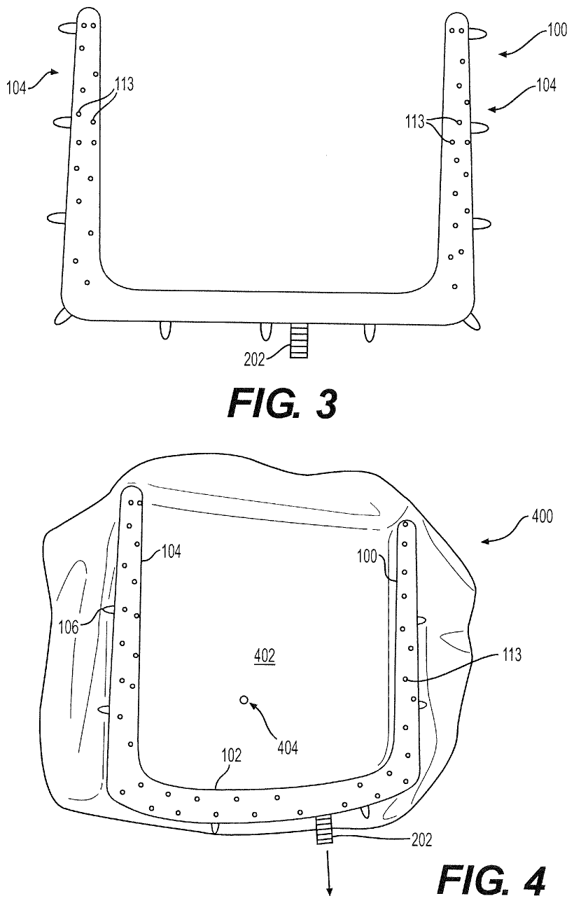

FIG. 4 shows an exemplary dental dam assembly 400 according to various exemplary embodiments. As shown in FIG. 4, the dental dam assembly 400 includes the frame 100 with a pliable material 402 stretched over the frame 100 and held in place by the plurality of protrusions 106. In some embodiments, the pliable material 402 may be rubber. However, it should be noted that any other suitable elastic material that is sterile may alternatively be used. For example, the pliable material 402 may be formed of latex. As also illustrated in FIG. 4, the pliable material 402 includes an opening 404 that can be placed on a surgical site to isolate the surgical site from its surroundings. In use, dental dam assembly 400 is placed adjacent the patient's face such that the frame 100 surrounds the patient's mouth. The pliable material 402 sits over the patient's mouth and prevents any surgical tools or other material from falling into the patient's mouth. In some embodiments, the frame 100 may also include openings 113 along the base 102 of the frame 100, as shown in FIG. 4. In the embodiment shown in FIG. 4, the pliable material 402 sits atop the patient's face and the frame 100 sits atop the pliable material 402 (i.e., the pliable material 402 is beneath the frame 100). In this embodiment, the openings 113 would be disposed through the surface of the frame 100 further away from the pliable material 402 so as not to suck the pliable material 402 into any of the openings 113.

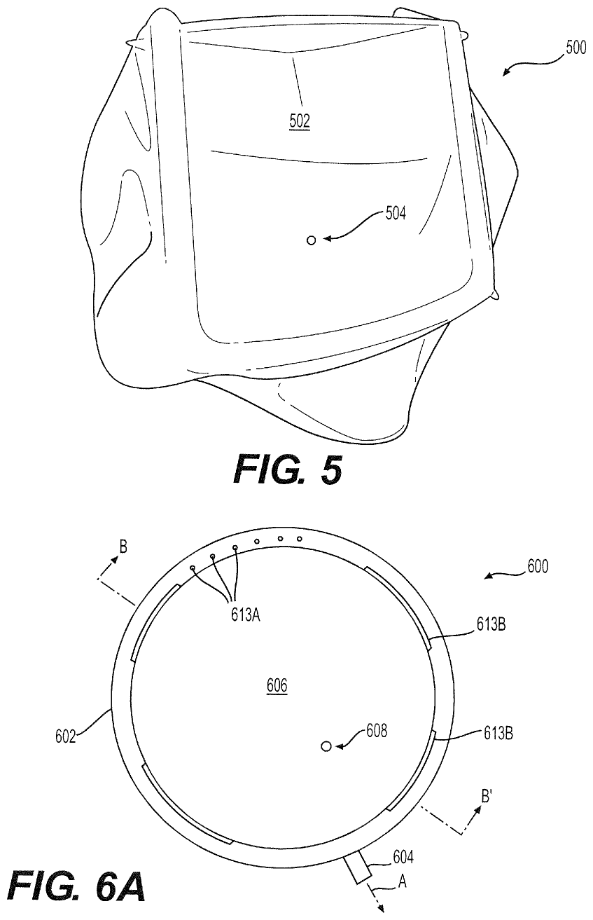

FIG. 5 shows an exemplary dental dam assembly 500 according to various exemplary embodiments. The dental dam assembly 500 is substantially similar to the dental dam assembly 400 described above. For example, the dental dam assembly 500 also includes a pliable material 502 stretched over the frame 100 (not visible in FIG. 5) and an opening 504 configured to be placed over the surgical site. In the dental dam assembly 500, however, the frame 100 is placed atop the patient's face and the pliable material 502 is disposed above the frame 100 (i.e., the frame 100 is beneath the pliable material 502). In this embodiment, the openings 113 would be disposed through the surface of the frame 100 further away from the pliable material 402 (i.e., closer to the patient's face) so as not to suck the pliable material 402 into any of the openings 113.

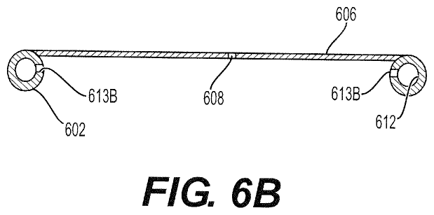

In the above examples, it was described that the exemplary frames have the openings 113 on one side of the frame 100. However, it is possible to have the openings on both sides of the frame 100. As described above, in such embodiments, the openings 113 should be designed (e.g., sized and shaped) such that the pliable material is not sucked into the openings when in use. In other exemplary embodiments, including the embodiments described below with respect to FIGS. 6A-B, the pliable material may be confined to an interior of the frame such that the pliable material is not over any openings even if the openings are on both sides of the frame. In the exemplary embodiments described above, those skilled in the art will understand that the pliable material may also be confined to the interior of the frame.

FIG. 6A shows an exemplary dental dam assembly 600 according to various exemplary embodiments. FIG. 6B is a cross-sectional view of the dental dam assembly of FIG. 6A taken along B-B′. The dental dam 600 functions substantially similarly to the dental dam assemblies 400, 500 described above. The dental dam assembly 600 also includes a frame 602 having a central channel 612, a plurality of openings 613 in fluid communication with the central channel 612, and a connection port 604 also in fluid communication with the central channel 612. A pliable material 606 having an opening 608 is also coupled to the frame 602. However, in the embodiment of FIGS. 6A and 6B, the pliable material 606 is permanently coupled to the frame 602 such that the entire dental dam assembly 600 is a one-time use assembly (i.e., disposable). The pliable material 606 may be permanently coupled to the frame 602 via any conventional means such as, for example, adhesives, plastic welding, clamping, etc.

As noted above in the description of FIG. 3, the openings in the frame can include slits. FIGS. 6A and 6B depict the frame 600 including a plurality of openings including holes 613A and slits 613B. It should be noted that the configuration depicted in FIGS. 6A and 6B are exemplary and that any combination of holes 613A, 613B, or any other type of opening may be utilized to achieve the desired vacuum environment adjacent a patient's mouth. The holes 613A may be advantageously useful for evacuating patient breath whereas the slits 613B may be advantageously useful for evacuating aerosol generated by the dental procedure. However, both aerosol and patient breath may be evacuated through both (and any other) types of openings.

In use, the surgeon places the dental dam assembly 400, 500, 600 adjacent the patient's mouth and aligns the opening with the target surgical site. A vacuum line is coupled to the connection port of the dental dam assembly 400, 500, 600 and a vacuum source coupled to the line is turned on. As a result, the patient's breath and any aerosol generated during the procedure is evacuated through the frame and line and is advantageously prevented from becoming airborne and possibly infecting anyone in the procedure room.

In the above examples, the frames were described as having a general U-shape or a circular shape. While these may be the most common shapes for dental dams, those skilled in the art will understand that the frame may be formed in other shapes that are advantageous for dental procedures.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It will be apparent to those skilled in the art that various modifications may be made in the present disclosure, without departing from the spirit or the scope of the disclosure. For example, the frames discussed above may have various overall and cross-sectional shapes and sizes. Thus, it is intended that the present disclosure cover modifications and variations of this disclosure provided they come within the scope of the appended claims and their equivalent.

What is claimed:

1. A dental dam frame, comprising:
a tubular body having a central channel;
a plurality of openings extending from an exterior surface of the tubular body and in fluid communication with the central channel; and
a connection port extending from the tubular body and in fluid communication with the central channel, wherein the connection port is configured to be coupled to a vacuum line to provide a negative pressure area adjacent the tubular body.

2. The dental dam frame of claim 1, further comprising:
a plurality of protrusions extending outwardly from the tubular body, the plurality of protrusions configured to hold a pliable material extending over the tubular body, wherein the pliable material includes an opening configured to be disposed over a target anatomical site.

3. The dental dam frame of claim 2, wherein the plurality of protrusions are arranged such that the pliable material is disposed above the tubular body.

4. The dental dam frame of claim 2, wherein the plurality of protrusions are arranged such that the pliable material is disposed below the tubular body.

5. The dental dam frame of claim 1, wherein the tubular body includes a base and two arms extending from opposite ends of the base.

6. The dental dam frame of claim 5, wherein the plurality of openings are distributed along the two arms.

7. The dental dam frame of claim 5, wherein the plurality of openings are distributed along the base.

8. The dental dam frame of claim 1, further comprising:
a pliable material permanently coupled to the tubular body, wherein the pliable material includes an opening configured to be disposed over a target anatomical site.

9. The dental dam frame of claim 8, wherein the pliable material is disposed above the tubular body.

10. The dental dam frame of claim 8, wherein the pliable material is disposed beneath the tubular body.

11. A dental dam, comprising:
a tubular body having a central channel;
a plurality of openings extending from an exterior surface of the tubular body and in fluid communication with the central channel;
a connection port extending from the tubular body and in fluid communication with the central channel, wherein the connection port is configured to be coupled to a vacuum line to provide a negative pressure area adjacent the tubular body; and
a pliable material permanently coupled to the tubular body, wherein the pliable material includes an opening configured to be disposed over a target anatomical site.

12. The dental dam of claim 11, wherein the pliable material is disposed above the tubular body.

13. The dental dam of claim 11, wherein the pliable material is disposed beneath the tubular body.

14. The dental dam of claim 11, wherein the dental dam is disposable.

15. A dental dam, comprising:
a tubular body having a central channel;
a plurality of openings extending from an exterior surface of the tubular body and in fluid communication with the central channel;
a connection port extending from the tubular body and in fluid communication with the central channel, wherein the connection port is configured to be coupled to a vacuum line to provide a negative pressure area adjacent the tubular body;
a plurality of protrusions extending outwardly from the tubular body; and
a pliable material extending over the tubular body and held in place by the plurality of protrusions, wherein the pliable material includes an opening configured to be disposed over a target anatomical site.

16. The dental dam of claim 15, wherein the pliable material is disposed above the tubular body.

17. The dental dam of claim 15, wherein the pliable material is disposed beneath the tubular body.

18. The dental dam of claim 15, wherein the tubular body includes a base and two arms extending from opposite ends of the base.

19. The dental dam of claim 18, wherein the plurality of openings are distributed along the two arms.

20. The dental dam of claim 18, wherein the plurality of openings are distributed along the base.
